(19) United States
(12) Patent Application Publication
(10) Pub. No.: US 2007/0002225 A1
(43) Pub. Date: Jan. 4, 2007

(54) Transflective type liquid crystal display device and method of driving the same

(75) Inventor: Heume Il Baek, Anyang-Si (KR)

Correspondence Address: BRINKS HOFER GILSON & LIONE, P.O. BOX 10395, CHICAGO, IL, 60610, US

(73) Assignee: LG PHILIPS LCD CO., LTD.

(21) Appl. No.: 11/320,246

(22) Filed: Dec. 28, 2005

(30) Foreign Application Priority Data
Jun. 29, 2005 (KR) 2005-057254

(51) Int. Cl. G02F 1/1335

(52) U.S. Cl. 349/114

(57) ABSTRACT

A transflective liquid crystal display is set forth that comprises first and second substrates disposed opposite one another and a liquid crystal layer disposed between the substrates. The first substrate includes a red pixel region, a green pixel region, a blue pixel region and a white pixel region defined thereon. Each of the red, green, blue and white pixel regions has a respective transmission region and a respective reflection region associated with the pixel. An offset brightness is applied to the display at the white pixel region. The offset brightness of the white pixel region may be operable, for example, to compensate for differences in appearance of the transflective liquid crystal display that would otherwise occur between operation of the display in a transmission mode of operation and a reflective mode of operation. The red, green, blue and white pixel regions may be organized into color regions that are arranged for use in generating individual colors that, in turn, are used in the generation of a display image. A method for operating such a transflective liquid crystal display device is also disclosed.

### BACKGROUND OF THE INVENTION

1. Field of the Invention

The present invention relates to a liquid crystal display (LCD) device. More particularly, the present invention relates to a transflective type LCD device and a method of operating the same.

2. Description of the Related Art

In general, flat panel displays can be classified as light receiving types or light emitting types. Light emitting displays use materials that can be stimulated to generate the light that produces the image, while light receiving displays use an external light source to generate an image using an external light source. Examples of light emitting displays include plasma display panels (PDPs), field emission displays, and electro-luminescence displays. Light receiving displays include LCD devices.

LCD displays are often superior in resolution, color display, picture quality and the like, when compared to many other types of display devices. Consequently, LCD displays are widely used as monitors for notebook computers, desktop computers, high-definition television screens, etc.

There are a number of different ways to construct an LCD display. Most LCD displays include two substrates that are each provided with respective electrodes formed thereon so that the electrodes of the substrates face one another when the LCD display is assembled. A liquid crystal layer is interposed between the two substrates. When voltages are applied to the electrodes of the two substrates, an electric field is generated and applied to the liquid crystal layer. The LCD device generates images when the liquid crystal molecules of the liquid crystal material are manipulated using the electric field to control the transmittance of light through individual portions of the liquid crystal layer.

As noted above, LCD displays utilize an external light source to generate an image since the liquid crystal material itself does not generate light. The external light may come from an ambient source or may be integrated with the LCD display. To this end, many LCD displays are provided with a backlight unit disposed proximate the liquid crystal material. The LCD displays an image by controlling the light emanating from the backlight unit through the liquid crystal panel.

LCD displays that employ a backlight or the like as the external light source are generally referred to as transmission type LCD displays. Since such transmission type LCD displays employ an artificial backlight source, they can provide a bright image even in a dark environment. However, such transmission type LCD displays consume a substantial amount of power, which can be a disadvantage in various situations.

LCD displays that employ ambient light as the extra light source are known as reflection type LCD displays. Such reflection type LCD displays generate an image by reflecting external natural light or artificial light and adjusting the transmittance of that light according to the alignment of liquid crystal molecules. Since the reflection type LCD devices do not need a backlight unit, they do not consume as much power as their transmission type counterparts. In these reflection type LCD displays, pixel electrodes on the lower substrate are formed of a conductive material having a high reflectivity. A common electrode on the upper substrate is formed of a transparent conductive material to allow the transmission of external light.

Although reflection type LCD devices have the advantage of low power consumption, the generated image may be difficult or impossible to view if the ambient light does not have a sufficient intensity. Consequently, such LCD devices frequently cannot be used in low-light conditions.

Transflective type LCD displays have been proposed in an attempt to overcome some of the disadvantages associated with both transmission type LCD displays and reflection type LCD displays. The transflective type LCD display may operate in multiple modes. More particularly, transflective type LCD displays can be selectively driven in either the transmission mode or the reflection mode of operation.

FIG. 1 is a sectional view of an exemplary transflective type LCD display. As shown, the LCD display includes a lower substrate 1, an upper substrate 70, and a liquid crystal layer 60 interposed between the lower substrate 1 and the upper substrate 70. In the lower substrate 1, a gate electrode 6 and a gate line (not shown) are formed on a transparent substrate 2. A gate insulating layer 10 is formed on the resulting transparent substrate 2, including on the gate electrode 6 and the gate line. An active layer 13 and an ohmic contact layer 16a, 16b are disposed over the gate insulating layer 10 on the gate electrode 6. Source and drain electrodes 23 and 26 are formed on the ohmic contact layer 16a, 16b such that they are spaced apart from each other. In this manner, a thin film transistor (Tr) is formed, at least in part, by the gate electrode 6, the active layer 13, the ohmic contact layer 16a, 16b, and the source and drain electrodes 23 and 26. A data line 20 is also formed on the gate insulating layer 10 in the same layer as the source and drain electrodes 23 and 26. The data line 20 is formed integrally with the source electrode 23 so that they are electrically connected with one another. The data line 20 intersects the gate line (not shown) to define a pixel region ‘SP’.

A first passivation layer 30 is formed on the resulting transparent substrate 2 including the thin film transistor (Tr). Passivation layer 30 may be formed using an organic insulator having a low dielectric constant. A reflection plate 40 is formed of a metal material having a high reflectivity on the first passivation layer 30 within a reflection area ‘RA’. A second passivation layer 45 is formed on the first passivation layer 30, including on the reflection plate 40. The second passivation layer 45 may be formed using an inorganic insulating material. A pixel electrode 50, which electrically contacts the drain electrode 26 of the thin film transistor (Tr) through a drain contact hole 55, is formed on the second passivation layer 45 within the pixel region ‘SP’.

In the upper substrate 70, a black matrix 75 shaped in a lattice configuration is formed on a transparent substrate 71. Red (R), green (G) and blue (B) color filters 80a, 80b and 80c are formed on the transparent substrate 71 including the black matrix 75. On the color filters 80a, 80b and 80c, an over coat layer 85 and a transparent conductive common electrode 90 are formed. Each of the color filters 80a, 80b and 80c is formed at a position so that it is aligned with corresponding pixel electrodes 50. The black matrix 75 is formed at positions corresponding to the thin film transistor (Tr) region, the gate line and the data line 20.

A liquid crystal layer 60 is interposed between the pixel electrode 50 and the common electrode 90. Liquid crystal molecules of the liquid crystal layer 60 are realigned by an electric field generated when a voltage difference is applied between the pixel electrode 50 and the common electrode 90.

In the exemplary transflective type LCD display device, cell gap ‘d1’ of the reflection area ‘RA’ and cell gap ‘d2’ of the transmission area ‘TA’ have substantially the same thickness. As a result, neither the cell efficiency at the reflection area ‘RA’ or the cell efficiency at transmission area ‘TA’ are optimal, and the transmittance and the brightness may be less than desired. Also, in the reflection mode operation, external light passes through the color filters twice—the first being before it is incident onto the reflection plate and the second after it is reflected by the reflection plate. In contrast, light emitting from the backlight unit disposed below the liquid crystal panel passes through the color filters only one time in the transmission mode of operation. A difference in color characteristics may exist between the reflection mode and the transmission mode. Such differences may be problematic.

An exemplary transflective type LCD display that attempts to address the color differences is shown in FIGS. 2A, 2B and 3. FIGS. 2A and 2B are partial plan views of a transflective type LCD display having a transmission hole and a double cell gap, while FIG. 3 is a sectional view taken along the line A-A of FIG. 2B.

As shown in FIGS. 2A and 2B, the transflective type LCD display includes a plurality of gate lines 3 that are arranged in a horizontal direction (with respect to the orientation of the figure), and a plurality of data lines 20 that are arranged in a vertical direction. Pixel regions ‘SP’ are defined where the plurality of gate lines 3 and the plurality of data lines 20 cross one another. Thin film transistors (Tr) are formed at intersecting points of the plurality of gate lines 3 and the plurality of data lines 20. Red (R), green (G), and blue (B) color filters are formed corresponding to the respective pixel regions ‘SP’. Each of the pixel regions includes a transmission area ‘TA’ formed at a center thereof, and a reflection area ‘RA’ around the transmission area ‘TA’. The reflection area ‘RA’ is formed with a reflection plate (not shown). Although not shown in the drawings, the passivation layer has been removed in the region of the transmission area ‘TA’ to form a step height difference with respect the reflection area ‘RA’. As a result, the cell gap of the reflection area ‘RA’ is different from the cell gap of the transmission area ‘TA’. In the reflection area ‘RA’, the color filter is partially removed to form a circular transmission hole ‘TH’. FIG. 2A shows that the transmission hole ‘TH’ from which the color filter is removed is formed above and below the transmission area ‘TA’. FIG. 2B shows another embodiment in which a plurality of transmission holes ‘TH’ enclose each transmission area ‘TA’ and are formed on substantially the whole reflection area ‘RA’.

FIG. 3 is a cross-sectional view through the transflective type LCD display shown in FIG. 2A. Like reference numerals in FIGS. 1 and 3 denote like elements, and thus their description will be omitted.

In the transmission area ‘TA’ of the lower substrate 1, the first passivation layer 30 is removed so that the cell gap ‘d4’ of the transmission area ‘TA’ is twice the thickness of the cell gap d3 of the reflection area ‘RA’. When the cell gap of the transmission area is different from that of the reflection area, the cell operates in an electrically controlled birefringence (ECB) mode. Whenever the cell gap is increased by a factor of two, the transmittance curve can be periodically repeated to obtain the same cell efficiency of the transmission area ‘TA’ as that of the reflection area ‘RA’. Consequently, it is possible to concurrently maximize both the cell efficiency of the reflection area ‘RA’ and the cell efficiency of the transmission area ‘TA’.

In the upper substrate 70, the black matrix 75 is formed so that it is aligned with the data line 20 of the lower substrate 1 on the transparent substrate 71. Likewise, the red, green and blue color filters 80a, 80b and 80c are formed so that they are aligned with the respective pixel regions ‘SP’ of the lower substrate 1 on the black matrix 75. A portion of the color filter layer corresponding to the reflection area ‘RA’ having the reflection plate 40 is removed to form the transmission hole ‘TH’, and the transmission hole ‘TH’ is filled with a transparent organic material constituting the over coat layer 85 formed on the red, green and blue color filters 80a, 80b and 80c. The common electrode 90 is formed on the over coat layer 85.

The circular transmission holes ‘TH’ are formed within the reflection area ‘RA’. Either the area of the circular transmission holes ‘TH’ or their number may be adjusted to decrease the color purity in the reflection area so that the color purity of the transmission area ‘TA’ substantially matches the color purity of the reflection area ‘RA’. Such adjustments may also be used to enhance the brightness characteristics of the reflection area ‘RA’. However, if the transmission holes ‘TH’ are formed in the manner shown in FIG. 3, the LCD display may become difficult to design and/or manufacture.

### SUMMARY OF THE INVENTION

A transflective liquid crystal display is set forth that comprises first and second substrates disposed opposite one another and a liquid crystal layer disposed between the substrates. The first substrate includes a red pixel region, a green pixel region, a blue pixel region and a white pixel region defined thereon. Each of the red, green, blue and white pixel regions has a respective transmission region and a respective reflection region associated with the pixel. An offset brightness is applied to the display at the white pixel region. The offset brightness of the white pixel region may be operable, for example, to compensate for differences in appearance of the transflective liquid crystal display that would otherwise occur between operation of the display in a transmission mode of operation and a reflective mode of operation. The red, green, blue and white pixel regions are organized into individual color regions that are arranged for use in generating individual colors that, in turn, are used in the generation of a display image. A method for operating such a transflective liquid crystal display device is also disclosed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a sectional view of an exemplary LCD display;

FIGS. 2A and 2B are partial plane views of an exemplary transflective type LCD display according to the related art;

FIG. 3 is a sectional view of the exemplary transflective type LCD display as taken along the line A-A of FIG. 2B;

FIG. 4 is a partial plane view of one embodiment of a transflective type LCD display constructed in accordance with the teachings of the present invention;

FIG. 5 is a sectional view of the transflective type LCD display taken along the line B-B of FIG. 4;

FIG. 6 is a chromaticity diagram using the CIE system of color specification to adjust the white offset used by the transflective LCD display of FIGS. 4 and 5; and

FIGS. 7A and 7B are graphs showing transmittance according to wavelength in a transflective type LCD device constructed in the manner shown in FIGS. 4 and 5.

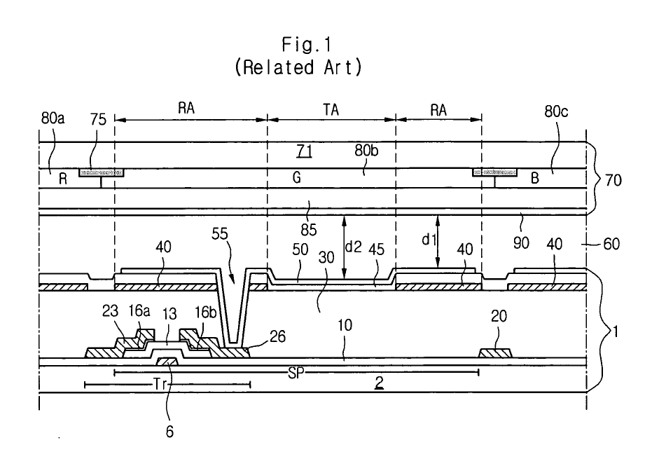

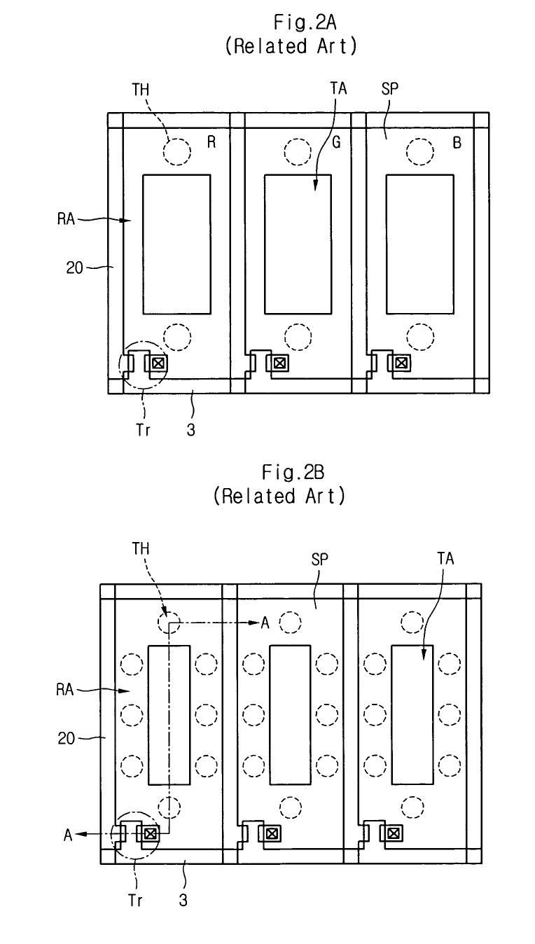

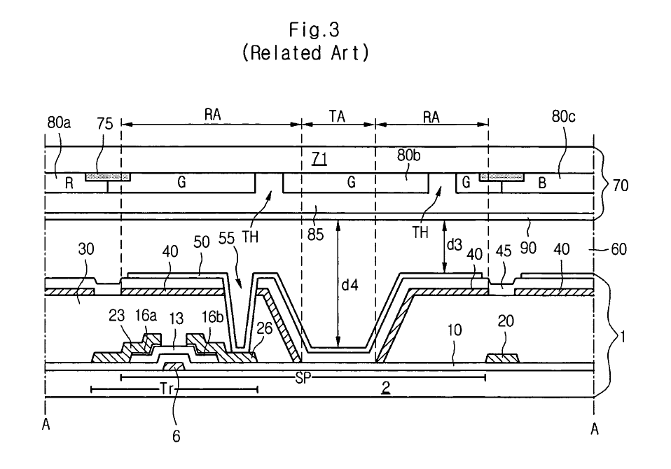

### DETAILED DESCRIPTION OF THE INVENTION

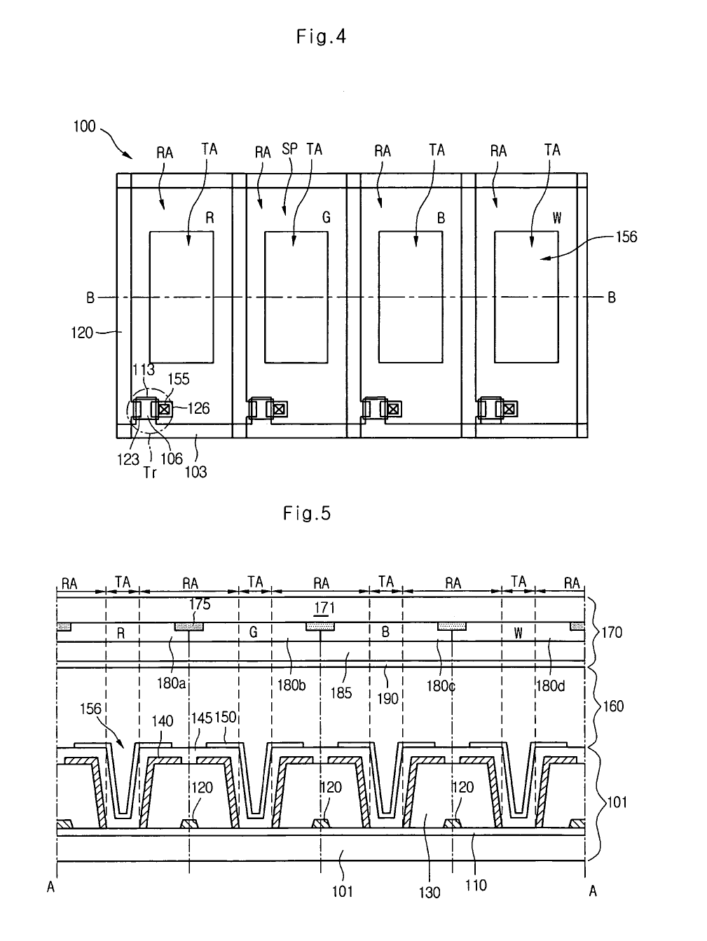

FIG. 4 is a partial plan view of one embodiment of a transflective type LCD display, while FIG. 5 is a sectional view taken along the line B-B of FIG. 4. With reference to these figures, the transflective type LCD display of this embodiment includes a plurality of horizontally oriented gate lines 103 that spaced apart from one another at, for example, constant intervals. A plurality of vertically oriented data lines 120 are arranged to cross the plurality of gate lines 103 and define a plurality of pixel regions ‘SP’ therebetween. The pixel regions ‘SP’ may be arranged as single color regions that each include a red (R) pixel region, a green (G) pixel region, a blue pixel region (B) and a white (W) pixel region. The single color region can display a desired color by combining the colors expressed in the respective pixel regions R, G, B and W. A thin film transistor (Tr) is disposed at the crossing of each gate line 103 and data line 120.

Red (R), green (G), blue (B) and white (W) color filters 180a, 180b, 180c and 180d are formed to overlie the respective pixel regions R, G, B and W. The white (W) color filter 180d can be formed of a thick over coat layer, a transparent insulating buffer layer, or the like.

Each of the pixel regions R, G, B and W includes a transmission area ‘TA’ and a reflection area ‘RA’ that encloses the transmission area ‘TA’. The transmission area ‘TA’ is formed proximate a center of the respective pixel region and has a predetermined area. The area ratio between the reflection area ‘RA’ and the transmission area ‘TA’ of each of the R, G and B pixel regions may be equal to or not equal to the area ratio between the reflection area ‘RA’ and the transmission area ‘TA’ in the W pixel region.

The transflective type LCD device also includes a lower substrate 101 having a thin film transistor (Tr) that operates as a switching element and a pixel electrode 150 connected with the thin film transistor. An upper substrate is also included and has red, green, blue and white color filter layers 180a, 180b, 180c and 180d and common electrode 190 formed therein. A liquid crystal layer 160 is interposed between the pixel electrode 150 of the lower substrate 101 and the common electrode 190 of the upper substrate 170.

The lower substrate 101 includes a transparent substrate 103. A gate electrode 106 and a gate line (not shown) are formed on the transparent substrate 101. A gate insulating layer 110 is formed on the transparent substrate 101, including over the gate electrode 106 and the gate line. Layer 110 may be formed from an inorganic insulator, such as silicon dioxide (SiO2) or silicon nitride (SiNx). An amorphous active layer 113 is formed corresponding to the gate electrode 106 on the gate insulating layer 110. An impurity-doped ohmic contact layer (not shown) is formed on the active layer 113 in the form of patterns spaced apart from each other. Metallic source and drain electrodes 123 and 126 are formed on the ohmic contact layer. Thin film transistor ‘Tr’ is formed, at least in part, by the gate electrode 106, the active layer 113, the ohmic contact layer and the source and drain electrodes 123 and 126. A data line 120 is formed integrally with the drain electrode 126 of the thin film transistor (Tr) and may be disposed in the same layer as the source and drain electrodes 123 and 126.

A first passivation layer 130 formed of an organic insulator, such as benzo cyclo butene (BCB) or photo acryl, is disposed on the source and drain electrodes 123 and 126 and the data line 120 within the reflection area ‘RA’. In the transmission area ‘TA’, the first passivation layer 130 is etched to expose the gate insulating layer 110 disposed below the first passivation layer 130, and also has a transmission hole 156 with a step height difference from the reflection area ‘RA’.

A reflection plate 140 formed of a metal having high reflectivity is disposed on the first passivation layer 130 within the reflection area ‘RA’. In the illustrated embodiment, the reflection plate 140 is formed on side surfaces and a predetermined portion of the upper surface of layer 130. The reflection plate 140 is partially removed from the reflection area ‘RA’ at the drain electrode 126. A second passivation layer 145 formed of an inorganic insulator, such as silicon dioxide (SiO₂) or silicon nitride (SiNx) is disposed on the reflection plate within the reflection area ‘RA’.

The first passivation layer 130 and the second passivation layer 145 are partially removed from an upper surface of the drain electrode 126 of the thin film transistor (Tr) to form a drain contact hole 155. A pixel electrode 150 is formed of a transparent conductive material, such as ITO or IZO, and is disposed on the second passivation layer 145 within the pixel region ‘SP’. The pixel electrode 150 contacts the drain electrode 126 through the drain contact hole 155.

The upper substrate 170 includes a transparent substrate 171 and a black matrix 175 formed on the transparent substrate 171. The red (R), green (G), blue (B) and white (W) color filters 180a, 180b, 180c and 180d are also disposed in the upper substrate 170. An over coat layer 185 and a common electrode formed of a transparent conductive material are disposed proximate the red (R), green (G), blue (B) and white (W) color filters 180a, 180b, 180c and 180d,.

The red (R), green (G), blue (B) and white (W) color filters 180a, 180b, 180c and 180d have a one-to-one correspondence with the pixel regions. The black matrix 175 partially overlaps edges of the pixel electrodes 150 and is aligned with and/or formed by the data line 120.

The red (R), green (G), and blue (B) color filters 180a, 180b, and 180c have red, green and blue color, respectively and the white (W) color filter 180d does not have any color. In particular, the white color filter 180d may be formed of a thick over coat layer or a transparent insulation buffer layer rather than a separate material so as to compensate for the step height difference from the red (R), green (G), and blue (B) color filters 180a, 180b, and 180c.

A liquid crystal layer 160 is disposed between the pixel electrode 150 and the common electrode 190. The liquid crystal molecules of the liquid crystal layer 160 are realigned when an electric field is applied between the pixel electrode 150 and the common electrode 190. This electric field is generated when a voltage differential is applied between the pixel electrode 150 and the common electrode 190.

The transflective LCD device may operate in multiple modes. When the amount of ambient light is high, the transflective type LCD device operates in the reflection mode. When the amount of ambient light is low, the transflective type LCD device operates in the transmission mode using a backlight or the like to enhance the brightness of the LCD display. In one or both modes, the white (W) pixel may be driven to an offset value in an effort to reduce any differences in the display of colors that would otherwise occur between the transmission mode of operation and the reflection mode of operation.

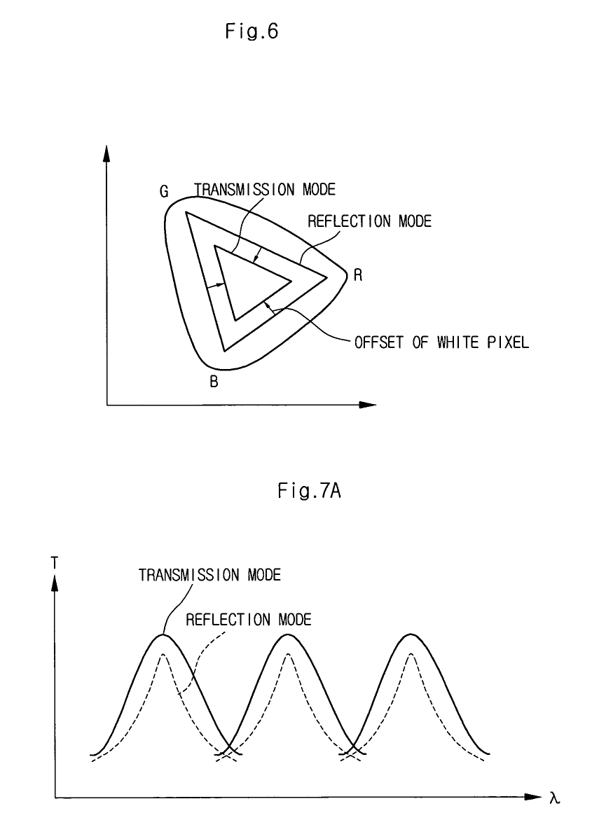

FIG. 6 is a chromaticity diagram using CIE system of color specification in the transflective LCD device. In general, the color reproduction range of the LCD device can be represented by the chromaticity diagram using the CIE system of color specification, in which each color can be described using a mixing ratio of an X tristimulus value (representing the degree of red stimulation by a light source), a Y tristimulus value (representing the degree the green stimulation by a light source), and a Z tristimulus value (representing the degree of blue stimulation by a light source). The X, Y, and Z values can be correlated with the measurements taken by a spectrophotometer.

The stimulus value is given by an integral value of a product of a spectrum of light generated from the backlight unit, a spectrum of light transmitting the color filter and a color matching function. Accordingly, the tristimulus values may be described by the following equations:

$$X = k {\int }_{380}^{780} ϕ ( λ ) \overline{x} ( λ ) ⅆ λ ;$$

$$Y = k {\int }_{380}^{780} ϕ ( λ ) \overline{y} ( λ ) ⅆ λ ; and$$

$$Z = k {\int }_{380}^{780} ϕ ( λ ) \overline{z} ( λ ) ⅆ λ ,$$

where φ (λ) is the spectrum of the source and where x̅(λ), y̅(λ), and z̅(λ) represents the corresponding red, green, and blue spectral wavelength distribution energies.

The ratio of the X, Y, Z tristimulus values may be used to define chromaticity coordinate for a given color. The chromaticity coordinate values x, y, z satisfy the relationship of x+y+z=1, and are respectively expressed by the following equations:

$$x = \frac{X}{X + Y + Z} ;$$

$$y = \frac{Y}{X + Y + Z} ; and$$

$$z = \frac{Z}{X + Y + Z} .$$

By using the above equations, all the colors can be expressed by three values of x, y and Y. Herein, Y is a brightness value and x and y are combined to one combination to represent the chromaticity and correspond to properties of color except for the brightness.

Using the exemplary diagram of FIG. 6, each color in the reflection mode and the transmission mode may be expressed as a single point within the saddle shape. As can be seen from the diagram, the range of color reproduction obtained solely by the use of the red, green, and blue pixels in the reflection mode differs from the range of color reproduction that is obtained solely by the use of the read, green, and blue pixels in the transmission mode. To compensate for this difference, the transflective LCD device drives the white (W) pixels of the display to one or more offset values so that the differences in the color reproduction ranges between the reflection mode and the transmission mode are substantially reduced.

The white offset used in the foregoing compensation scheme can be determined in a number of different manners. In the following example, the white offset value W₀ may be selected in accordance with the following equations:
W₀=Offset_{R}×R₁+Offset_{G}×G₁+Offset_{B}×B₁;
R₀, G₀, B₀=R₁, G₁, B₁

where
Offset_{R}+Offset_{G}+Offset_{B}≦1.

Red, green and blue offset (Offset_{R}, Offset_{G}, Offset_{B}) values are determined according to the color filter spectrum and the targeted color reproducing range. The targeted color reproduction range in the example shown in FIG. 6 is the color reproduction range of the transflective display when it operates in the transmission mode.

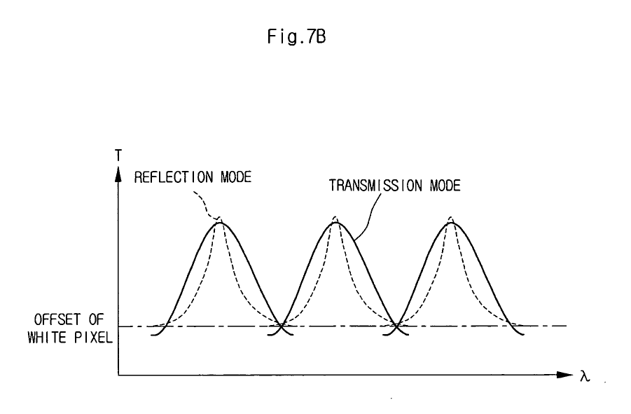

FIGS. 7A and 7B are graphs showing light transmittance (T) as a function of wavelength (λ) in the reflection and transmission modes of operation of the transflective LCD display. FIG. 7A illustrates the difference in light transmittance between the transmission mode and reflection mode that occurs without any white offset compensation applied to the white (w) pixels of the single color regions of the display. In contrast, FIG. 7B illustrates the light transmittance in the transmission mode and reflection mode that occurs when white offset compensation is applied to the white (W) pixels of each of the single color regions of the display. As seen from the graph of FIG. 7B, as the offset brightness of the white pixel region increases, the light transmittance increases compared with the uncompensated operation of the transflective LCD device shown in FIG. 7A. As such, the offset brightness produced by the white pixel regions reduced the differences in the light transmittance that would otherwise occur in the transflective LCD display between the transmission and reflection modes of operation.

The transflective type LCD shown above makes several advantages available to a designer wishing to exploit them. For example, the driving of the white pixels may be used in either the transmission mode or the reflection mode to enhance the overall brightness of the display. Further, the driving of the white pixels may be used in either mode, but particularly the reflection mode, to ensure that the range of colors experienced by a user appears substantially the same whether the transflective LCD display is in the transmission mode or the reflection mode. Still further, since the functionality previously provided by the conventional transmission holes is replaced by functionality provided by the white pixel regions, the design and/or manufacture of the transflective LCD display may be simplified and/or more readily enhanced with other design features.

It will be apparent to those skilled in the art that various modifications and variations can be made in the present invention. Thus, it is intended that the present invention cover the modifications and variations of this invention provided they come within the scope of the appended claims and their equivalents.

What is claimed is:

1. A transflective type liquid crystal display device comprising:
a first substrate having a red pixel region, a green pixel region, a blue pixel region and a white pixel region defined thereon, each of the red, green, blue and white pixel regions having a respective transmission region and a respective reflection region;
a second substrate disposed opposite the first substrate;
a liquid crystal layer interposed between the first substrate and the second substrate;
where an offset brightness is applied at the white pixel region.

2. The transflective liquid crystal display of claim 1, where the offset brightness of the white pixel region is operable to compensate for differences in appearance of the transflective liquid crystal display that would otherwise occur between operation of the transflective liquid crystal display in a transmission mode of operation and a reflective mode of operation.

3. The transflective liquid crystal display device according to claim 1, where a red color filter is provided at the red pixel region.

4. The transflective liquid crystal display device according to claim 1, where a blue color filter is provided at the blue pixel region.

5. The transflective liquid crystal display device according to claim 1, where a green color filter is provided at the green pixel region.

6. The transflective liquid crystal display device according to claim 1, where a transparent insulation material is provided at the white pixel region.

7. The transflective liquid crystal display device according to claim 6, where the transparent insulation material does not have a color component.

8. The transflective liquid crystal display device according to claim 1, where the first substrate comprises:
a plurality of gate lines and a plurality of data lines arranged to cross one another at each of the red, green, blue and white pixel regions;
a thin film transistor disposed as a switching transistor at the crossings between the plurality of gate lines and the plurality of data lines proximate each of the red, green, blue and white pixel regions;
a first passivation layer disposed over on a reflection region on the thin film transistor;
a reflection plate disposed over the first passivation layer;
a second passivation layer disposed over the substrate including the reflection plate; and
a pixel electrode disposed over the second passivation layer and electrically connected with the thin film transistor, and
wherein the second substrate comprises:
red, green, blue and white color filter layers formed respectively in the red, green, blue and white pixel regions;
a black matrix formed between the red, green, blue and white color filter layers; and
a common electrode disposed proximate the red, green, blue and white color filter layers.

9. The transflective liquid crystal display device according to claim 8, where the transmission region has a transmission hole with a step height difference from the reflection area.

10. The transflective liquid crystal display device according to claim 9, where the transmission hole is formed by etching the first passivation layer at the transmission region.

11. The transflective liquid crystal display device according to claim 9, where the reflection plate is formed on a side surface and a predetermined region of an upper surface of the first passivation layer.

12. The transflective liquid crystal display device according to claim 1, where the offset brightness of the white pixel region is greater in a reflection mode than in a transmission mode.

13. 12. A method of driving a transflective liquid crystal display device including a red pixel region, a green pixel region, a blue pixel region and a white pixel region constituting a unit color region, each pixel region having a reflection region and a transmission region, the method comprising:
applying an offset brightness to the white pixel region; and
driving the offset brightness to a level needed to adjust a color generated by the unit color region.

14. The method according to claim 13, where the offset brightness of the white pixel region is driven to a higher level when the transflective liquid crystal display device operates in a reflection mode as compared to when the transflective liquid crystal display device operates in a transmission mode.

15. The method according to claim 13, where light transmittance of the unit color region is varied by the offset brightness of the white pixel region.

16. The method according to claim 14, where light transmittance of the unit color region is increased in the reflection mode.
